(19) United States
(12) Patent Application Publication
(10) Pub. No.: US 2025/0007781 A1
(43) Pub. Date: Jan. 2, 2025

(54) SYSTEMS AND METHODS FOR CLUSTER-BASED PARALLEL SPLIT LEARNING

(71) Applicants: Xuemin SHEN, Waterloo (CA); Wen WU, Waterloo (CA); Mushu LI, Waterloo (CA); Kaige QU, Waterloo (CA); Weihua ZHUANG, Waterloo (CA); HUAWEI TECHNOLOGIES CANADA CO., LTD., Kanata (CA); ZHOU, Conghao

(72) Inventors: Xuemin SHEN, Waterloo (CA); Wen WU, Waterloo (CA); Mushu LI, Waterloo (CA); Kaige QU, Waterloo (CA); Conghao ZHOU, Waterloo (CA); Weihua ZHUANG, Waterloo (CA); Xu LI, Kanata (CA)

(73) Assignee: HUAWEI TECHNOLOGIES CANADA CO., LTD., Kanata, ON (CA)

(21) Appl. No.: 18/884,763

(22) Filed: Sep. 13, 2024

Related U.S. Application Data
(63) Continuation of application No. PCT/CA2022/050487, filed on Mar. 30, 2022.

(51) Int. Cl. H04L 41/0893; G06N 20/00; H04L 41/16

(52) U.S. Cl. CPC H04L 41/0893; G06N 20/00; H04L 41/16

(57) ABSTRACT

There is provided a method and apparatus associated with cluster-based parallel split learning. The method includes a network controller distributing a client-side model to a plurality of client devices in a cluster. The method also includes a server receiving a plurality of transmissions from each of the client devices, each transmission including smashed data and information about data used to generate the smashed data, and the server generating a gradient associated with the smashed data based at least in part on the transmissions. The method includes the server transmitting the gradient associated with the smashed data to the client devices, and the network controller receiving updated client-side models from each of the client devices. The method also includes the network controller generating an aggregated client-side model based on the received updated client-side models and transmitting the aggregated client-side model to a second cluster of client devices.

### CROSS-REFERENCE TO RELATED APPLICATIONS

This application is a continuation of International Patent Application No. PCT/CA2022/050487, filed Mar. 30, 2022, entitled “Systems and Methods for Cluster-Based Parallel Split Learning” the entire contents of which are incorporated herein by reference.

### TECHNICAL FIELD

The present disclosure pertains to the field of split learning in artificial intelligence, and in particular to system and methods for cluster-based parallel split learning.

### BACKGROUND

Split learning is an artificial intelligence (AI) technique which can be used to train an AI model using data from multiple different entities. These entities may not wish to share their data, as the data used to train the AI model may be sensitive due to privacy reasons. Split learning can allow each of these different entities to train the model without disclosing the data used to train the model itself.

Generally, when there are multiple different entities training the AI model, each entity interacts with the server to train the model in a sequential manner. After a client trains the model with the client's local data set, the client may transfer the client-side model to a next client which will then train the model with its local data. This process may result in the convergence of the AI model but may require the sequential participation of the client devices. The sequential nature of this process may be time-consuming, particularly when there are a large number of client devices working to train the AI model in a sequential manner. Therefore, there is a need for a system and a method which can accelerate split learning.

This background information is provided to reveal information believed by the applicant to be of possible relevance to the present disclosure. No admission is necessarily intended, nor should be construed, that any of the preceding information constitutes prior art against the present disclosure.

### SUMMARY

In one aspect, the present disclosure describes a method including distributing, by a network controller, a client-side model to a first plurality of client devices in a first cluster. The method also includes a server receiving a plurality of transmissions from each of the first plurality of client devices, each transmission including smashed data and information indicative of data used by a respective client device to generate the smashed data and the server generating gradients associated with the smashed data based at least in part on the transmissions. The method includes the server transmitting the gradients associated with the smashed data to the first plurality of client devices and then the network controller receiving updated client-side models from each of the first plurality of client devices. The method also includes the network controller generating an aggregated client-side model based, at least in part, on the received updated client-side models from the first plurality of client devices and distributing the aggregated client-side model to a second plurality of client devices in a second cluster. The server and the network controller using this method may be different entities or may both be the same entity.

The transmissions to and from the server may be transmitted via a wireless communication network. The network controller may be further configured to, prior to distributing the client-side models to the first cluster, determine a resource management allocation between client devices of the first plurality of client devices. To determine a resource management allocation, the network controller may: collect at least one of communication link conditions and computing capabilities of client devices in the first plurality of client devices, allocate at least one subcarrier to each client device in the first plurality of client devices, to form an allocation of subcarriers, calculate a latency associated with the allocation of subcarriers to the first plurality of client devices, and assign an additional subcarrier to a client device of the first plurality of client devices based at least in part on the latency associated with the allocation of subcarriers. The network controller may use this method iteratively, until all available subcarriers have been assigned to a client device, by determining whether there are further available subcarriers to assign and, if there are further available subcarriers to assign, repeating the steps of calculating the latency and assigning the additional subcarrier until all available subcarriers have been assigned.

In one aspect of the present disclosure, the information about data used to generate the smashed data may include one or more labels of data sampled by a client device of the first plurality of client devices. Distributing the client-side model may be done by transmitting the client-side model to the first plurality of client devices in the first cluster, such as by broadcasting the model to each client device or by unicasting the model to devices one at a time. Generating an aggregated client-side model may include generating the aggregated client-side model using a weighted average of the received updated client-side models, a weight in the weighted average based, at least in part, on a number of data samples used to generate the received updated client-side models.

In an aspect of the present disclosure, generating the gradients associated with the smashed data may include the server training a server-side model using the smashed data from the first plurality of client devices, and calculating gradients associated with the smashed data associated with a cut layer based at least in part on the trained server-side model.

According to one aspect of the disclosure, the method may include the network controller determining, prior to distributing the client-side model to the first plurality of client devices in the first cluster, a client clustering scheme which includes at least assigning the first plurality of client devices to the first cluster and assigning the second plurality of client devices to the second cluster. The client clustering scheme may be determined based at least in part on communication link conditions and computing capabilities associated with one or more client devices from the first plurality of client devices. The method may also include determining a timeout value associated with one or more of the first plurality of client devices, the timeout value based at least in part on the communication link conditions and the computing capabilities.

According to another aspect, an apparatus is provided, where the apparatus includes: a memory, configured to store a program; a processor, configured to execute the program stored in the memory, and when the program stored in the memory is executed, the processor is configured to perform one or more of the methods described herein.

In another aspect, a computer readable medium is provided, where the computer readable medium stores program code executed by a device, and the program code is used to perform one or more of the methods the described herein.

According to another aspect, a chip is provided, where the chip includes a processor and a data interface, and the processor reads, by using the data interface, an instruction stored in a memory, to perform one or more of the methods the described herein.

Other aspects of the disclosure provide for apparatus, and systems configured to implement one or more of the methods disclosed herein. For example, a server such as an edge server or a network controller can be configured with machine readable memory containing instructions, which when executed by the processors of these devices, configures the devices to perform one or more of the methods disclosed herein.

Embodiments have been described above in conjunctions with aspects of the present disclosure upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present disclosure will become apparent from the following detailed description, taken in combination with the appended drawings, in which:

FIG. 1 is an illustration of a procedure which uses split learning to train an artificial intelligence (AI) model, according to an aspect of the present disclosure.

FIG. 2 is an illustration of a split learning scheme which trains client devices in a sequential manner, according to an aspect of the present disclosure.

FIG. 3 is an illustration of a parallel split learning scheme in which client devices are grouped into several clusters, according to one aspect of the present disclosure

FIG. 4 is an illustration of a workflow of an intra-cluster learning stage, according to one aspect of the present disclosure.

FIG. 5 is an illustration of a workflow of an inter-cluster learning stage, according to one aspect of the present disclosure.

FIG. 6 illustrates a method for a Gibbs-sampling based client clustering scheme, according to one aspect of the present disclosure.

FIG. 7 illustrates a timeline of a parallel split learning scheme in a cluster, according to one aspect of the present disclosure.

FIG. 8 illustrates a method for resource management allocation, according to one aspect of the present disclosure.

FIG. 9 is a schematic diagram of an electronic device that may perform any of the steps of the above methods and features as described herein, according to an aspect of the present disclosure.

It will be noted that throughout the appended drawings, like features are identified by like reference numerals.

### DETAILED DESCRIPTION

Split learning is an artificial intelligence (AI) technique which can be used to generate an AI model based on local datasets from a plurality of client devices. In some split learning techniques, during each training round, each client device may sequentially train the AI model using its own local dataset. These techniques may ensure that the AI model converges, but they may not scale well as the number of client devices grows.

The use of clustering may improve split learning techniques by allowing for increased scalability, which may be particularly useful when there are many client devices. This clustering technique may be used to accelerate AI model convergence, such as when using deep neutral network (DNN) or other AI techniques. A split learning method may be operated on a server such as an edge server or a network controller, which itself may be part of an edge server. A network controller may cluster client devices into a plurality of clusters, with each cluster including one or more client devices. The network controller can be configured to simultaneously train its AI model on each client device in a cluster, and to train the AI model sequentially on each of the clusters. Cluster-based parallel split learning (CPSL) may be particularly beneficial in wireless networks, such as with resource-constraint Internet of Things (IoT) devices, as cluster-based split learning may reduce overhead which needs to be transmitted, since only small-volume device-side models, smashed data, and their gradients may need to be transferred.

The network controller may form clusters of client devices based on the communication link conditions, such as communication distance and link quality (e.g., user plane (UP) path composition and condition), to the server and the computing capabilities of each of the client devices. Each client device in a cluster may train an AI model, such as an augmented DNN, in parallel using their own local datasets, wherein each client device runs a copy of the client-side model locally. Because each client device in the cluster may be acting in parallel with the other client devices in the cluster, the techniques may be slowed by the slowest client device in the cluster. Thus, it can be beneficial to cluster client devices based on their likely speed in performing their portion of the split learning process, which can include their computing capabilities and communication distance and link quality. After each client device completes a round of training, the server may receive a client-side model from each of the client devices and may aggregate those models to obtain an aggregated client-side model. This aggregated client-side model may then be transferred to a next cluster of one or more client devices, which can then participate in the model training process. A training round may be complete when each cluster has participated in the training process, and subsequent training rounds may use either the same or different clustering of the client devices.

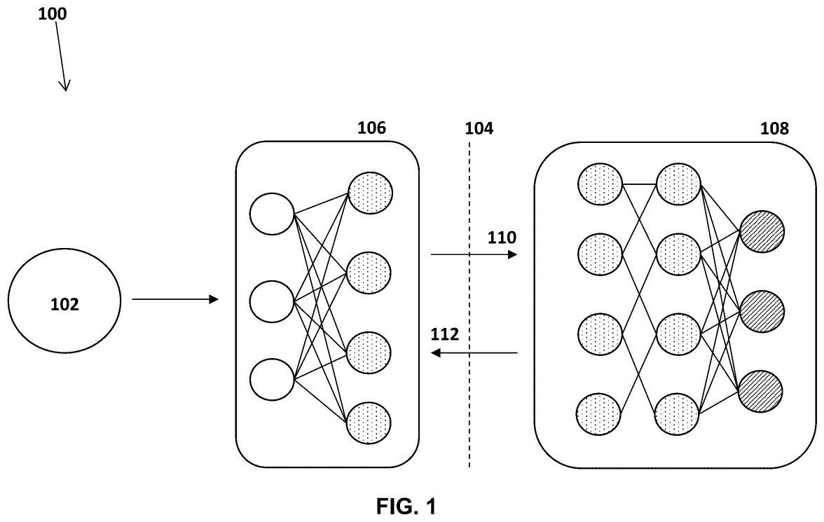

FIG. 1 is an illustration of a procedure 100 which uses split learning to train an AI model, according to an aspect of the present disclosure. Split learning is a distributed learning scheme which can train AI models among client devices (e.g., mobile devices) with the assistance of a server without sharing the local data of client devices. Split learning may be used on wired or wireless networks using one or more of an edge server (i.e. a server located at the network edge), a network controller, an access point (AP), or another device. The procedure 100 is an illustration of how to train a split learning artificial intelligence model for one client device. The whole AI model (a DNN model) can be partitioned into a client-side model 106 and a server-side model 108, e.g. along a hidden layer in the DNN model. The partition point (e.g. the hidden layer in the DNN model) is referred to as the cut layer 104. The model includes a client-side model 106, which is a front-end portion running on a client device. The model also includes a server-side model 108, which is a back-end portion which can run on a server (e.g. an edge server). In the following discussion, server and edge server are used inter-changeably.

Training the model for one client device includes two stages: forward propagation (FP) and backward propagation (BP). The client device and the server may exchange intermediate results related to the cut layer, such as transmitting smashed data to the edge server in the FP stage and transmitting gradients associated with the smashed data to the client device in the BP stage. The gradients associated with the smashed data are gradients associated with the cut layer and corresponding to the smashed data. The gradients associated with the smashed data can be referred to as the smashed data's gradients. In the FP stage, the client device trains the client-side model 106 with its local data 102 up to the cut layer 104. At the cut layer 104, the client device transmits its generated smashed data 110 to the edge server. In the BP stage, after receiving the smashed data 110, the edge server trains its server-side model 108 with the smashed data 110. The gradients are then back propagated again from a last layer until the cut layer 104, generating gradients associated with the smashed data 112. The gradients associated with the smashed data 112 may then be transmitted back to the client device to update its client-side model 106, which is then transmitted to the edge server. This completes one round of training of the AI model.

Generally, this procedure 100 allows the edge server to train its server-side model 108 without needing access to the local data 102 of the client device. As described, this procedure 100 allows a client device to train the AI model using its local data. The procedure 100 may then be sequentially repeated for other client devices, allowing an edge server to train its model using the data of multiple client devices without the edge server having access to that data of one or more of the client devices.

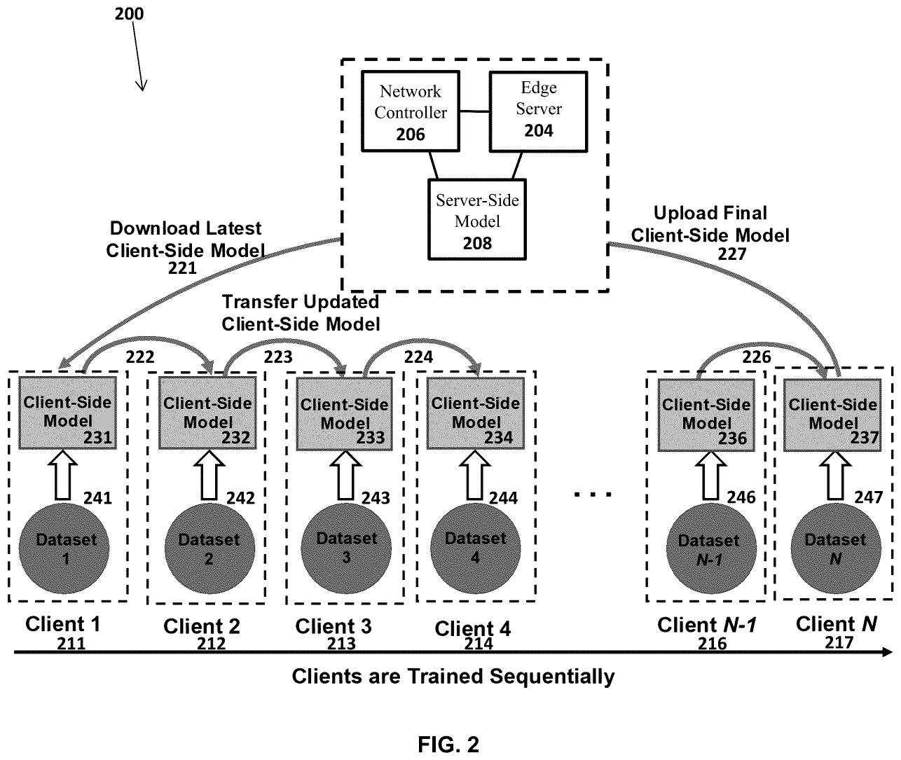

FIG. 2 is an illustration 200 of a split learning scheme which trains client devices in a sequential manner, according to an aspect of the present disclosure. The split learning scheme may be coordinated by a network controller 206. In some embodiments, the network controller 206 is located at, or integrated with an edge server 204. In other words, the network controller 206 and the edge server 204 may be the same entity. Prior to starting the model training, a first client device 211 obtains or downloads or receives 221 the latest client-side model 231, e.g. from the network controller 206. The first client 211 then trains the client-side model using its local dataset 241. This training process may use the procedure 100 described above. After the first client device 211 finishes training the client-side model and generating an updated client-side model 232, the updated model 232 is transferred 222 from the first client device 211 to the second client device 212, e.g. via the network controller 206. This training process then repeats itself, with the model sequentially being updated by each of N client devices, each training the model using their own local datasets. Finally, the Nth client device 217 may train the model using its local dataset 247 and may upload or transmit 227 the final client-side model to the network controller 206. This upload/transmission 227 of the final-client side model completes one training round. Multiple training rounds may be needed until the trained AI model can achieve a satisfactory performance.

This split learning scheme may suffer from significant long training delay, particularly when there are a lot of client devices. Since the client devices are trained in a sequential manner, the training delay in the existing split learning scheme is accumulated across client devices, which may be proportional to the number of client devices. When the number of client devices is large, a significantly long training delay may be incurred. Therefore, it may be desirable to develop acceleration schemes for split learning to provide improved performance and scalability.

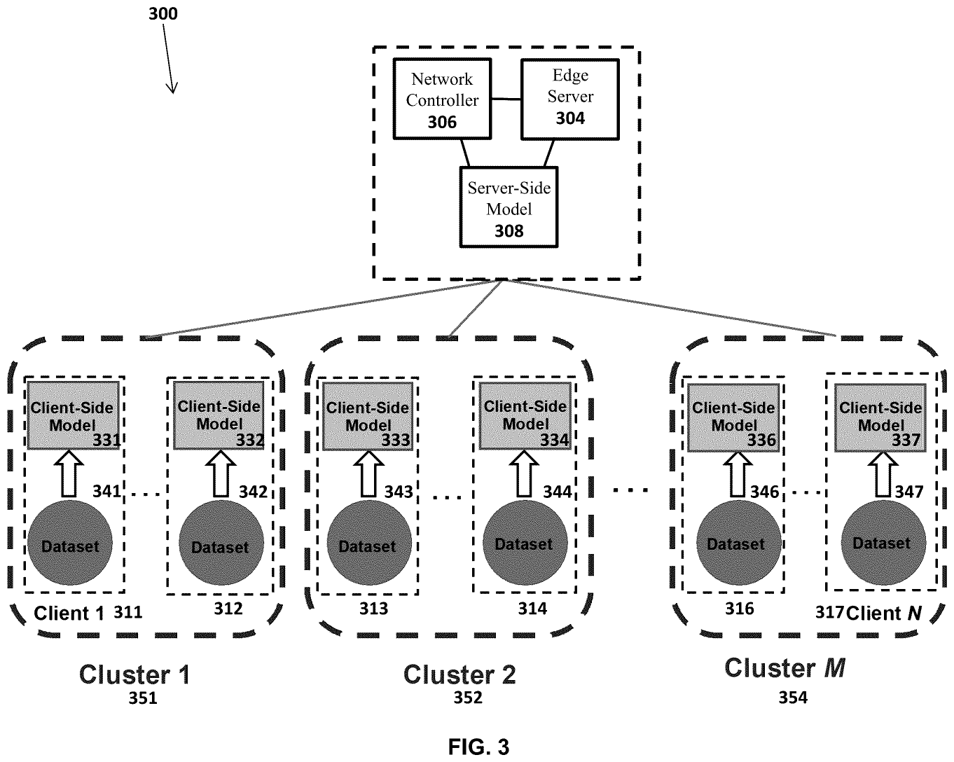

FIG. 3 is an illustration of a parallel split learning scheme 300 in which client devices are grouped into several clusters, according to one aspect of the present disclosure. The parallel split learning scheme 300 can enable cluster-based split learning to facilitate parallel client-side model training. This scheme 300 can be used to reduce training delay and improve scalability of split learning techniques, particularly when there are a lot of client devices. The scheme 300 may include a network controller 306 and a server, such as edge server 304. Generally, the edge server 304 may be configured to use the server-side model 308, while the network controller 306 may be configured to perform network functions, such as distributing client-side models to the client devices. The network controller 306 and the edge server 304 may be combined into a single entity or device, such that the network controller 306 is part of the edge server 304. Alternatively, the network controller 306 may be a separate entity or device, such as being a control entity in a telecommunication network, while the server running the server-side model 308 may be an entity located outside the telecommunication network. The method may function similarly whether or not the network controller 306 and the server running the server-side model 308 are a single entity or device.

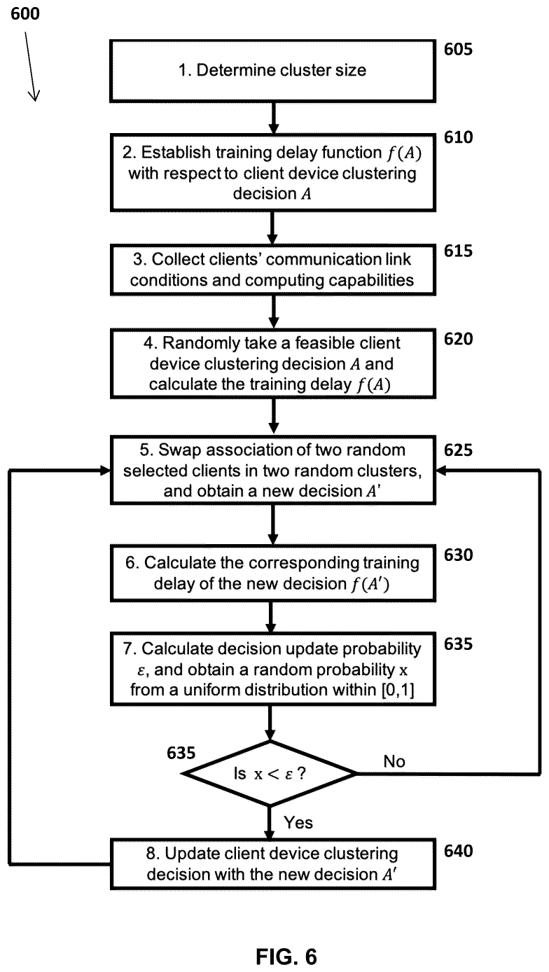

Prior to running the parallel split learning scheme 300, the client devices may be grouped into a plurality of clusters. For example, N client devices may be grouped in M clusters. It will be readily understood that a particular cluster may have one or more client devices associated therewith. This grouping or clustering of the client devices may be performed by the network controller 306 (for example, using a method as illustrated in FIG. 6), and can be at least in part based on the relative computing capabilities and network connections of each of the client devices. The one or more client devices in a particular cluster of the M clusters may perform model training in parallel with one another. Each training round of the parallel split learning scheme 300 may include two stages. The first stage may be intra-cluster learning, which allows each client device within one cluster to participate in model training in parallel. The first stage may result in the creation of an aggregated client-side model. The second stage of the parallel split learning scheme 300 includes inter-cluster learning, which transfers the aggregated client-side model from one cluster to another cluster in a sequential manner, such as transferring an aggregated client-side model generated by Cluster 1 351 to Cluster 2 352, to allow the client devices 313, 314 in Cluster 2 352 to participate in a round of intra-cluster training. The transferring of the aggregated client-side model can be performed with the assistance from the network controller 306. For example, the network controller 306 may receive a client-side model from each of the devices in the Cluster 1 351 and generate the aggregated client-side model by aggregating the received individual client-side models, and distributing (e.g. transmitting) the aggregated client-side model to the Cluster 2 352 (i.e. to every device in the Cluster 2 352). This process may continue with each cluster sequentially participating in the training process until all clusters have had the chance to train the model. Thus, within each individual cluster, the associated client devices may work in parallel with one another while each cluster trains the model sequentially.

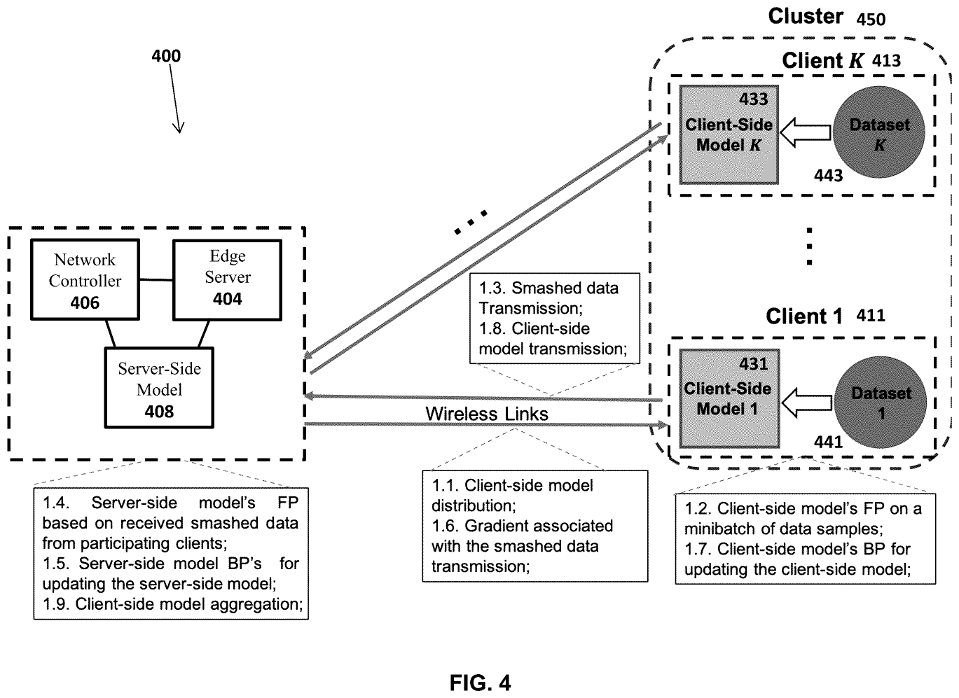

FIG. 4 is an illustration of a workflow of an intra-cluster learning stage 400, according to one aspect of the present disclosure. The intra-cluster learning stage 400 may be run by a server such as an edge server 404 and a network controller 406. The edge server 404 and the network controller 406 may be combined into a single entity or device or may be different devices with the edge server 404 running the server-side model 408 and the network controller 406 communicating with each client device 411, 413. The intra-cluster learning stage 400 begins when the edge server 404 (or network controller 406) distributes the latest client-side model (e.g. an aggregated client-side model) to each of the participating client devices in a cluster 450. For example, the cluster 450 may include K client devices from a first client device 411 to a Kth client device 413. The client-side model may be distributed using a wireless link between the edge server 404 (or network controller 406) and each client device 411, 413, or by other suitable connection that would be readily appreciated by one of ordinary skill in the art. The edge server 404 or network controller 406 may distribute the client-side model to each of the participating client devices by transmitting the model to each of the participating client devices. This transmission may be a broadcast transmission to each participating client device, or it may also transmit the client-side model in other ways, such as unicasting the client-side model to each of the participating client devices. When client devices in the intra-cluster learning stage 400 are connected using a wireless link, the edge server 404 or a network controller 406 associated therewith may allocate wireless spectrum recourses to the client devices 411, 413. These resources may be allocated in a manner which is likely to lead to the lowest overall training delay associated with the cluster. For example, reducing training delay may be accomplished by allocating more wireless spectrum resources to client devices which would otherwise slow down the intra-cluster learning stage 400.

After receiving the client-side model, each client device 411, 413 in the cluster 450 may sample a mini-batch of its respective dataset 441, 443 and execute FP on its client-side model 431, 433 to generate smashed data associated with the cut layer. Each client device 411, 413 may then transmit its generated smashed data associated with the cut layer and information about its data, such as labels of the sampled mini-batch data, to the edge server 404. For example, each client device 411, 413 may transmit information about the number of data points/items it possesses and used to train the model, which may assist the edge server 404 in weighting the input from each of the client devices 411, 413. As illustrated, the intra-cluster learning stage 400 may include substantial parallel training, such as each client device 411, 413 sampling a mini batch of its dataset 441, 443 at the same time as the other client devices in the cluster, and each client device 411, 415 generating and transmitting smashed data to the edge server 404 at the same time as the other client devices in the cluster. The edge server 404 may be configured to wait for each client device 411, 413 to finish its transmission of smashed data, so the overall process may be limited by the speed of the slowest client device. Accordingly, it may be advantageous to cluster client devices and to assign network resources based on each client device's expected speed, which may minimize this transmission delay.

After receiving the smashed data and labels, the edge server 404 may train its server-side model 408 using this smashed data. The edge server 404 may then use the training results and the labels to calculate a loss function to update the server-side model 408 via BP. The edge server 404 may then calculate the gradients associated with the smashed data associated with the cut layer. The edge server 404 may then transmit the gradients associated with the smashed data to each of the client devices 411, 413 in the cluster, such as transmitting the gradient associated with the smashed data using a wireless communication network. The gradients associated with the smashed data are associated with the cut layer. The edge server 404 transmits the gradients associated with the smashed data that the client device 411 transmitted to the edge server 404 to the client device 411, and the gradients associated with the smashed data that the client device 413 transmitted to the edge server 404 to the client device 413. In other words, the gradients transmitted to the client device 411 and those transmitted to the client device 413 are respectively correspond to the smashed data they transmitted to the edge server 404 and may be different.

Each client device 411, 413 may then update its client-side model 431, 433 based on the received gradients associated with the smashed data (the smashed data being those that the client device 411, 413 transmitted to the edge server respectively). Each client device 411, 413 may then transmit its updated client-side model 431, 433, denoted by ωₖ, ∀k=1, 2, . . . , K, to the edge server 404 or network controller 406, where K denotes the number of participating client devices in the cluster, and k denotes the index of a client device. As before, each client device 411, 413 associated with the cluster may work in parallel with one another to update its client-side model and to transmit its client-side model to the network controller 406 or edge server 404. Thus, as before, the overall process may be slowed by the slowest client device in the cluster, so it may be advantageous to cluster client devices and to assign network resources to client devices based on their expected speed.

The network controller 406 or edge server 404 may then aggregate the client-side models to generate/calculate an aggregated client-side model. For example, the network controller 406 may use a weighted aggregate of the client-side models based on a number of data samples that each client device possesses, with the formula ω=Σₖ₌₁^{K}ωₖDₖ/Σₖ₌₁^{K}Dₖ, where Dₖ denotes the number of data samples possessed in the dataset of client device k. It will be readily understood that other methods of aggregation of the client-side models can be used and are to be considered to be within the scope of the present disclosure.

The network controller 406 or edge server 404 may be provided information to be used for this aggregation by the client devices 411, 413, such as having each of the client devices transmit labels of data sampled by the client device 411, 413 which is used to train its client-side model. After the edge server 404 has generated/calculated the aggregated client-side model, the intra-cluster learning stage may conclude/finish, and the inter-cluster learning stage may begin with the network controller 406 or the edge server 404 distributing the aggregated client-side model to the client devices associated with a different cluster. The above method can subsequently be performed by this different cluster and each subsequent cluster until each of the clusters have performed the method of updating the client-side model being trained.

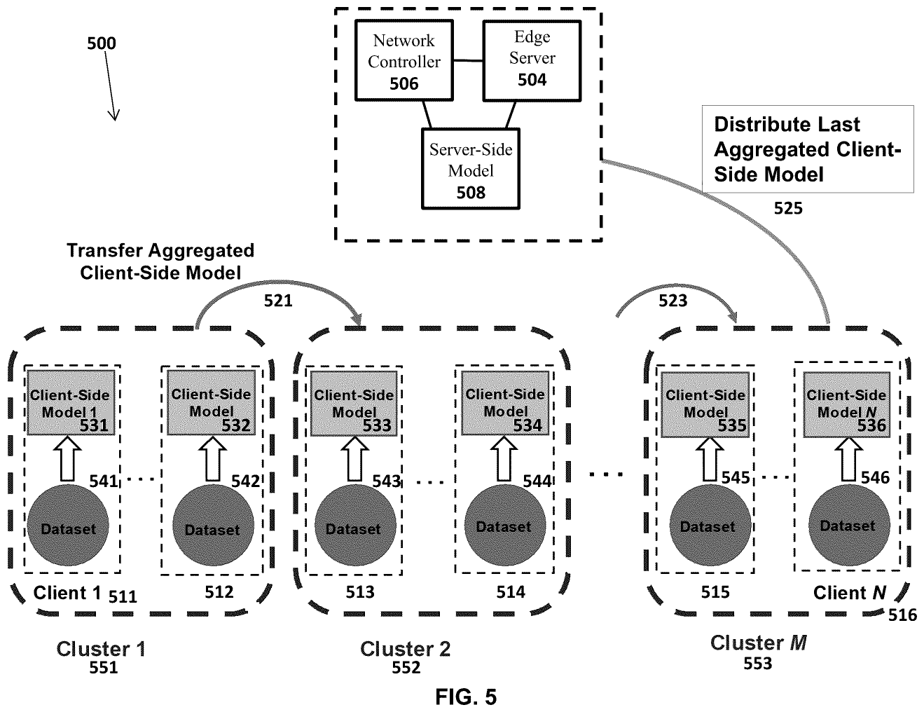

FIG. 5 is an illustration of a workflow of an inter-cluster learning stage 500, according to one aspect of the present disclosure. First, the edge server 504 or the network controller 506 associated therewith may group a plurality of client devices into a cluster. It will be readily understood that a cluster of client devices can include one or more client devices and the number of client devices can vary among the clusters. The edge server 504 or the network controller 506 may be configured to cluster devices in a manner which may minimize overall training delay, such as grouping client devices based on, e.g., communication link conditions, such as real-time channel conditions, and computing capabilities of the client devices. The edge server 504 or the network controller 506 may be configured to create multiple clusters at the same time or may be configured to create a next cluster of client devices when it has completed or finished with the creation of the current cluster, based in part on which client devices are available. For example, the edge server 504 may group a plurality of client devices 513, 514 into a second cluster 552 after a first cluster 551 has been used to generate an aggregated client-side model.

Once a next active cluster has been selected, the edge server 504 or the network controller 506 may distribute an aggregated client-side model, which is generated/calculated based on client-side models received from devices in a previous cluster (or simply speaking, generated/calculated by a previous cluster), to the participating client devices in a next cluster. For example, the edge server 504 may transmit 521 an aggregated client-side model generated by the first cluster 551 to the client devices 513, 514 in the second cluster 552. The aggregated client-side model itself may be generated in an intra-cluster learning stage 400, as described above. After receiving the aggregated client-side model, the client devices 513, 514 in the second cluster 552 may use the model in their own intra-cluster learning stage, like those described above.

Each of the clusters may be trained in a sequential manner. Once the final cluster 553 has completed its intra-cluster training, the final aggregated client-side model is generated/calculated by the edge server 504 or the network controller 506. If the final aggregated client-side model is generated/calculated by the network controller 506, the network controller 506 may provide/transmit the final aggregated client-side model to the edge server 504. This may complete one training round using a cluster-based parallel split learning scheme. In some aspects, multiple training rounds may be used to train the model, using either the same clusters or different clusters in each round. After the multiple training rounds are finished, the AI model is successfully trained, and the trained AI model includes the last aggregated client-side model and the server-side model. The network controller 506 or the edge server 504 may distribute/transmit 525 the last aggregated client-side model to all the devices (including devices in every cluster).

This cluster-based parallel split learning scheme can reduce overall training delay and generate an accurate AI model with improved speed when compared to a sequential technique. One benefit of such a scheme is that the client-side model training within each cluster can be performed in a parallel manner. For example, each of the client-side operations in the intra-cluster learning stage, such as client-side model distribution (step 1.1), client-side model's FP (step 1.2), smashed data transmission (step 1.3), transmission of gradients associated with the smashed data (step 1.6), client-side model's BP (step 1.7), and client-side model transmission (step 1.8), may be conducted/performed in parallel at each client device in a cluster rather than needing to be conducted sequentially for each client device. This parallelization of the steps can substantially reduce the overall training delay of the scheme, especially when there are many client devices.

Additionally, the inter-cluster learning stage may help ensure overall convergence of the parallel split learning process. One potential reason for this convergence is because the inter-cluster learning behaves in a sequential manner (step 2.3). This may be comparable to other split learning schemes which sequentially work through each client device, such that the parallel split learning process may be able to preserve model convergence and accuracy.

FIG. 6 illustrates a method 600 for a Gibbs-sampling based client device clustering scheme, according to one aspect of the present disclosure. While client device clustering can reduce training delay generally, it may also introduce straggler effect due to client device heterogeneity. Client device clustering decisions can impact the training delay of a parallel split learning scheme because the edge server may need to wait for updates from all the participating client devices in a cluster. Thus, straggler client devices with poor network connections (such as poor channel conditions) and/or low computation capabilities can slow down the whole training process. To help alleviate straggler effects, an edge server or network control may determine client device clustering decisions according to client devices' communication link conditions and computing capabilities. For example, the method 600 may seek to cluster client devices with similar expected speeds in completing their tasks, including both their computation speed and their network connection. These client device clustering decisions may be determined at the beginning of a training process and used for the entire training process, or may optionally be repeated each training round for a next training round.

According to embodiments, the client device clustering process may include the following steps.

First, a cluster size may be determined for each of the client device clusters at block 605, which dictates how many client devices may be in each of the clusters. We may first assume that each cluster has the same cluster size, and then determine which cluster size may minimize overall training delay. The overall training delay may be a product of the number of required training rounds until convergence ƒ(K) and the per-round training delay g(K). The training delay may be represented as T(K)=ƒ(K)g(K) where K is the cluster size. Here, both ƒ(K) and g(K) are functions related to the cluster size.

The number of training rounds needed until convergence ƒ(K) may depend on the data used to train the AI model. Each client device may be configured to sample a portion of its dataset as a representative dataset, based on which the method 600 may conduct model training and measure the number of required training rounds with respect to various cluster sizes. For example, this model training may include selecting several typical cluster sizes and subsequently conducting model training on a small representative dataset and subsequently measure the corresponding number of required training rounds for convergence.

Subsequently, based on these results, namely an evaluated relationship between cluster size and required training rounds for convergence, the function ƒ(K) can be approximated. Based on a plurality of simulation results, it has been generally demonstrated that ƒ(K) increases when K is larger, which means a large cluster size may slow down model convergence and require additional training rounds.

The per-round training delay g(K) can be obtained via analysis of a proposed client device clustering scheme based on average client devices' communication link conditions and computing capabilities and the edge server's computing capability. Generally, g(K) may decrease when K is larger, with larger cluster sizes (and thus fewer clusters) leading to shorter per-round training delays. Based on these results for ƒ(K) and g(K), an overall training delay T(K) can be estimated, such that an optimal cluster size can be estimated by minimizing T(K).

After adopting a client cluster size, the method 600 may then determine how to divide the client devices into the clusters. Generally, dividing client devices into clusters may be a combinatorial optimization problem. A Gibbs-sampling based scheme may be developed which can use an iterative process to determine client device clustering to optimize the speed of the model training process. The method 600 may be performed by a network controller and/or an edge server.

At block 610, the method 600 includes establishing a training delay function ƒ(A) with respect to client device clustering decision A. For example, the training delay function ƒ(A) may be an estimate of the amount of training delay that a split learning procedure will incur with a particular client device clustering decision. This training delay function may partly be an approximation based on sampled data that may be used in the AI model. A step-by-step approach may be applied to the training delay analysis of the parallel split learning scheme.

At block 615, the method 600 includes collecting client devices' communication link conditions, such as stochastic channel conditions, and computing capabilities. This information may be sufficient to estimate the speed at which each of the client devices will be able to perform the computation and transmission steps in the split learning procedures described herein. This information can also be estimated or approximated based on client devices' historical data, for example in instances where real-time information is not available. A network controller may be configured to divide the client devices into clusters based on these communication link conditions and computing capabilities.

At block 620, the method 600 includes randomly taking a feasible client device clustering decision A and calculating the training delay ƒ(A). The client device clustering decision A may be used as an initial decision to begin an iterative process, while the training delay may be calculated based on the collected information of client devices, such as their respective communication link conditions and computing capabilities. In some aspects, other initial clustering decisions may be used, rather than a random decision, such as decisions based on grouping client devices with similar estimated individual training delays.

At block 625, the method 600 includes swapping the cluster association of two randomly selected client devices in two randomly selected clusters to obtain a new clustering decision A′. For example, client device n may be selected from cluster m and client device n′ may be selected from cluster m′. The association of these two client devices may be swapped, placing client device n in cluster m′, and placing client device n′ in cluster m. This method may be used to obtain a new clustering decision A′. It will be readily understood that other methods of determining new clustering decisions may additionally or alternatively be used.

At block 630, the method 600 includes calculating a corresponding training delay function of the new clustering decision ƒ(A′).

At block 635, the method 600 includes calculating a decision update probability based on the formula

$$ε = \frac{1}{1 + {e}^{( f ( {A}^{′} ) - f ( A ) ) / δ}} ∈ [ 0 , 1 ] .$$

Here, δ>0 is the smooth factor, which is used to control the tendency of new decision exploration. Generally, a larger value of δ may tend to explore new decisions with a higher probability. A random probability x may be drawn from a uniform distribution within [0, 1] for a comparison with ε.

At block 640, the method 600 includes comparing the value of x with ε. If x is not larger than &, the method 600 may discard the new clustering decision A′ and return to block 625 to determine and evaluate a different clustering decision. If x is larger than ε, at block 645, the method includes updating the client device clustering decision with the new decision A′. The method 600 may then return to block 625 to determine and evaluate a different clustering decision. Each of blocks 625, 630, 635, 640, and 645 may be repeated until the client device clustering scheme converges.

The method 600 of client device clustering may be useful as it may accommodate client heterogeneity and may reduce per-round training delay. The method 600 at block 615 collects client device heterogeneity information, such as communication link conditions and computing capabilities of client devices, and the client device clustering decision takes this information into account in order to attempt to accommodate client device heterogeneity. The method 600 at blocks 635, 645 may update the client device clustering decision with a probability depending on the performance gain of the new decision over the previous one. This overall comparison of the client device clustering decision may avoid the client device clustering decision being trapped based on a local optimum when a global optimum is desired. Through iterating blocks 625, 630, 635, 640, and 645, the method 600 can evaluate many possible decisions to obtain an optimized client clustering decision. In some instances, an optimized client device clustering decision may reduce the training delay to one training round through efficient clustering of client devices.

The client device clustering decision may be further refined to reduce training delay. Although the method 600 can help alleviate the straggler effect, the straggler effect may still be present when all clusters are the same size. This may be due to wide disparities in client device computing capabilities and communication link conditions. If this is the case, even within a single cluster, each client device's training delay may vary within a wide range. In these scenarios, it may be beneficial to refine a client device clustering decision.

Generally, these refinements may include offloading client devices in one cluster to another cluster. Two types of client devices may be offloaded: Quick client devices which have shorter training times than other client devices in their cluster, and straggler client devices which have longer training times than other client devices in their cluster. Offloading these client devices may reduce total training delay. Given a particular client device clustering decision with similar cluster sizes, it can be possible to calculate a training delay of each cluster. Let [symbol] ={1, 2, 3, . . . , M} denote the set of clusters, such as clusters which were determined using method 600.

For cluster m, a straggler client device in the cluster can be identified. Then, this identified straggler client device can be tentatively associated to each of the other clusters and subsequently calculate the corresponding total training delay for each of these clusters. It is desired to identify the cluster m′ which achieves a minimum training delay when the straggler client device is associated with that cluster. The straggler client device can then be associated with cluster m′. However, cluster m′ may be cluster m if the straggler device was already assigned to an optimal cluster which was achieving the minimum training delay.

A similar process may also be used for quick client devices in a cluster, such as in cluster m. These client devices may also be tried in other clustering decisions, to place the client devices into a cluster which results in a minimal training delay. These steps may then be repeated for each cluster m of all of the clusters [symbol] . In this way, both quick and straggler client devices may be offloaded to client device clusters which can minimize overall training delay. Through this process, the client device cluster sizes may vary between different client device clusters. For example, a first cluster and a second cluster may have different sizes, such that the clusters contain a different number of client devices. In addition, this process may be used to refine the client device clustering decisions of method 600 to further alleviate the straggler effect.

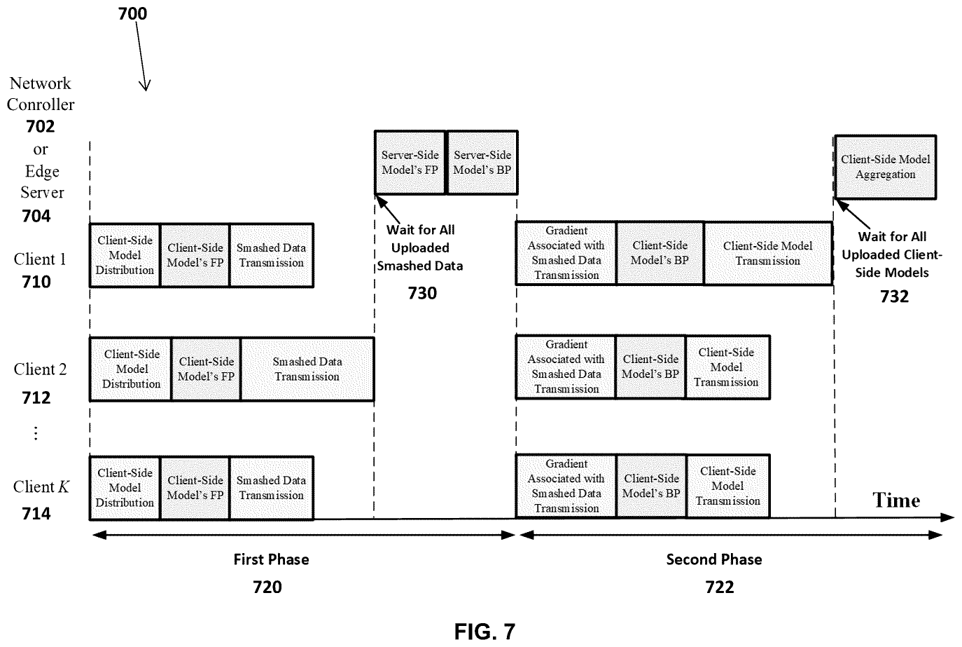

FIG. 7 illustrates a timeline 700 of a parallel split learning scheme in a cluster, according to one aspect of the present disclosure. The timeline 700 illustrates that the edge server 704 may need to wait for updates from all the devices 710, 712, 714 in two phases 720, 722.

During the first phase 720, each client device 710, 712, 714 in a cluster may perform client-side model distribution, execute the client-side model with their local dataset, and transmit smashed data to the edge server 704. Each client device 710, 712, 714 may perform these actions in parallel with one another, and each client device 710, 712, 714 may take different amounts of time to complete these tasks based on their respective communication link conditions, computing capabilities, among other factors. The edge server 704 may be configured to wait for a time 730 when it has received all the smashed data from each of the client devices 710, 712, 714 before the edge server 704 may update its server-side model as described above.

During the second phase 722, each client device 710, 712, 714 may receive the gradients associated with the smashed data (the smashed data being those that the client device 710, 712, 714 transmitted to the edge server 704 respectively) from the edge server 704, update their client-side model through BP, and transmit their updated client-side models to the edge server 704 or the network controller 702. As with the first phase 720, each client device 710, 712, 714 may perform these tasks in parallel with one another and may take differing amounts of time to complete these three tasks. The edge server 704 or the network controller 702 may be configured to wait for a time 732 at which it has received client-side models from each of the client devices 710, 712, 714 in the cluster before it can proceed with its client-side model aggregation.

In each of the first phase 720 and the second phase 722, a training delay may depend on the slowest client device in the cluster. These potential delays can be reduced by both the client device clustering decisions and by spectrum resource allocation to the client devices. For example, a resource management scheme may allocate spectrum resources judiciously to client devices based on real-time network dynamics to reduce training delay by reducing transmission times for client devices that may otherwise slow down the training process.

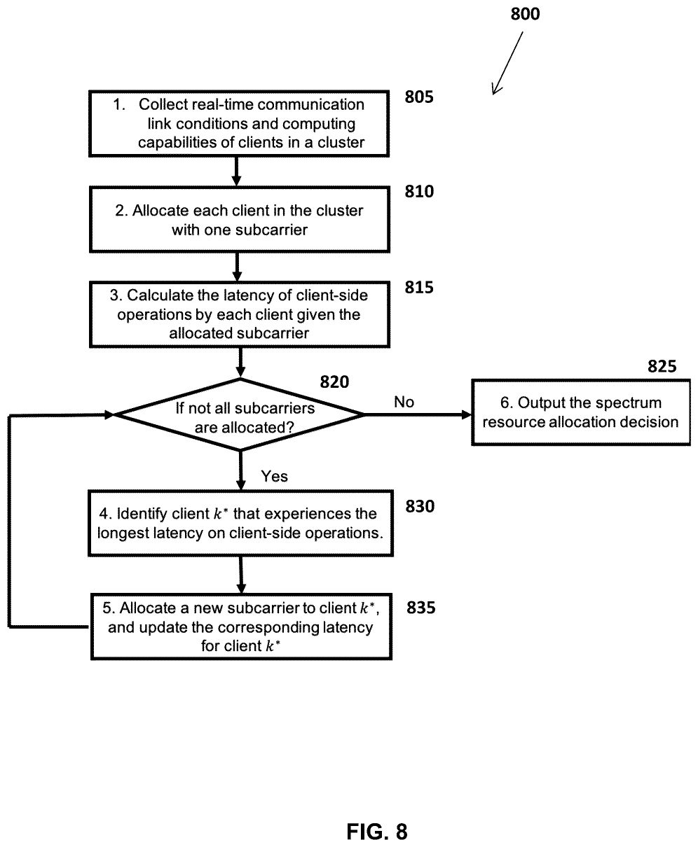

FIG. 8 illustrates a method 800 for resource management allocation, according to one aspect of the present disclosure. The method 800 may be done by an edge server (e.g. edge server 304, 404, 504 or 704) and/or a network controller (e.g. network controller 306, 406, 506 or 702) or by another device as part of a split learning process as described in the present disclosure. Generally, the edge server may be configured to use the server-side model, while the network controller may be configured to perform network functions, such as distributing client-side models to the client devices and determining the device clustering scheme (i.e. creating device clusters). The network controller and the edge server may be combined into a single entity or device, such that the network controller is part of the edge server. Alternatively, the network controller may be a separate entity or device, such as being a control entity in a telecommunication network, while the server running the server-side model may be an entity located outside the telecommunication network. The method may function similarly whether or not the network controller and the server running the server-side model are a single entity or device. The method 800 illustrates a greedy-based resource management scheme which is designed to allocate subcarriers to client devices in each cluster.

At block 805, the method 800 includes collecting communication link conditions, such as real-time channel conditions, and computing capabilities of client devices in a cluster. These conditions may indicate how quickly a client device may be able to receive and transmit models and data as part of a split learning process.

At block 810, the method 800 includes allocating each client device in the cluster with one subcarrier. For example, K may denote the number of client devices in a cluster. The spectrum resources may be allocated in the unit of a subcarrier. The spectrum allocation decision may be denoted by x=[x₁, x₂, . . . xₖ, . . . , x_{K}] where xₖ represents the number of subcarriers allocated to client device k. The initial values for each xₖ may be 1, representing that each client device in the cluster begins with an allocation of a single subcarrier.

At block 815, the method 800 includes calculating the latency of client-side operation by each client device given the allocated subcarriers. The latency for client device k may be denoted by g(xₖ), ∀k=1, 2, . . . , K.

At block 820, the method 800 includes checking whether all available subcarriers have been allocated. For example, a network controller may have a fixed number of subcarriers which it can allocate. Each cluster of client devices may include fewer devices than the network controller has subcarriers, and the network controller may be configured to allocate each of its subcarriers to one client device.

If all the available subcarriers have been allocated, at block 825, the method 800 includes outputting the spectrum resource allocation decision.

At block 830, if not all subcarriers have been allocated, the method 800 includes identifying the client device k* which experiences the longest latency on client-side operations, according to the formula

$${k}^{*} = {arg max}_{k = 1 , 2 , … , K} g ( {x}_{k} ) .$$

At block 835, the method 800 includes allocating an additional subcarrier to client device k*, i.e., xₖ′=xₖ′+1, and updating the corresponding latency for client device k*. The method 800 then returns to block 820, thereby repeating the method 800 until each available subcarrier has been allocated to a client device.

The method 800 may be applied to each of the two phases 720, 722 in timeline 700 by adopting different parameters of the client-side operations. For example, in the first phase 720 the client-side operations include client-side model distribution, client-side model's FP, and smashed data transmission, while in the second phase 722, the client-side operations include transmission of the gradients associated with the smashed data, client-side model's BP, and client-side model transmission. The method 800 may therefore use a different subcarrier allocation during the first phase 720 and the second phase 722 to minimize training delay in each phase.

The method 800 may be configured to accommodate network dynamics. The method 800 includes collecting the client devices' real-time computing capabilities and communication link conditions, such as channel conditions for a wireless communication network, and allocating the spectrum taking these network dynamics into account. If real-time figures are not available, the method may also use other data such as historical computing capabilities and/or communication link conditions. The method 800 may also reduce per-cluster training delay. One reason for this is because the method 800 allocates subcarriers in an incremental manner. In the beginning, each client device may be allocated one subcarrier, as in block 810. Then, an additional subcarrier may be allocated to the slowest client device iteratively until all subcarriers are allocated, as in block 835. In this way, the per-cluster training delay can be reduced.

In some respects, parts of the disclosure as described above may be described with reference to a static scenario, in which client devices covered by (associated with) the edge server are presumed to always be available. That is, the number of client devices in each training round may be assumed to be unchanged. However, the number of client devices may also change over time, such as due to user mobility, network disconnection, and sleep operation of client devices among other reasons. In addition, during the parallel split learning, client-side operations can be interrupted due to network disconnections and client device interruption. If left unchecked, these conditions could lead to training delays if one client device disconnects during client-side model training and if the other client devices are forced to wait for this disconnected device. These conditions could also lead to biased model training if client devices with poor network connections are given fewer opportunities to participate in model training than those with good network conditions, resulting in a biased trained model. However, the methods described above may be successfully adjusted to overcome these issues.

For example, a timeout mechanism may be used to help address training delay issues. The network controller or the edge server may collect communication link conditions and computing capabilities at the beginning of an intra-cluster learning step. Knowing this client device-specific information, the network controller or the edge server may be able to accurately estimate a timeout value for each participating client in a cluster. This value may be the same for each client device in a cluster or may be different for each client device. After a timeout period of a client device occurs, the network controller or the edge server may be configured to disregard an update from the client device. The network controller or the edge server then may continue conducting its server-side operations when this timeout period elapses, thereby avoiding a long training delay due to the disconnection or unavailability of a client device.

The network controller or the edge server may also be configured to avoid biased model training issues. For example, the network controller or the edge server may use a client device clustering scheme which takes client device fairness into account to attempt to avoid using a biased sample. One way to do this may be to use a participation counter function to record the number of training rounds in which each client device has participated. Client devices with intermittent or poor network connections may have a smaller counter value. Then, taking the participation counter into account, a modified client device clustering scheme can increase the opportunities of client devices with lower counter values to participate in the model training process. This method can help ensure client device fairness and work to attempt to minimize potential detrimental effects from biased model training.

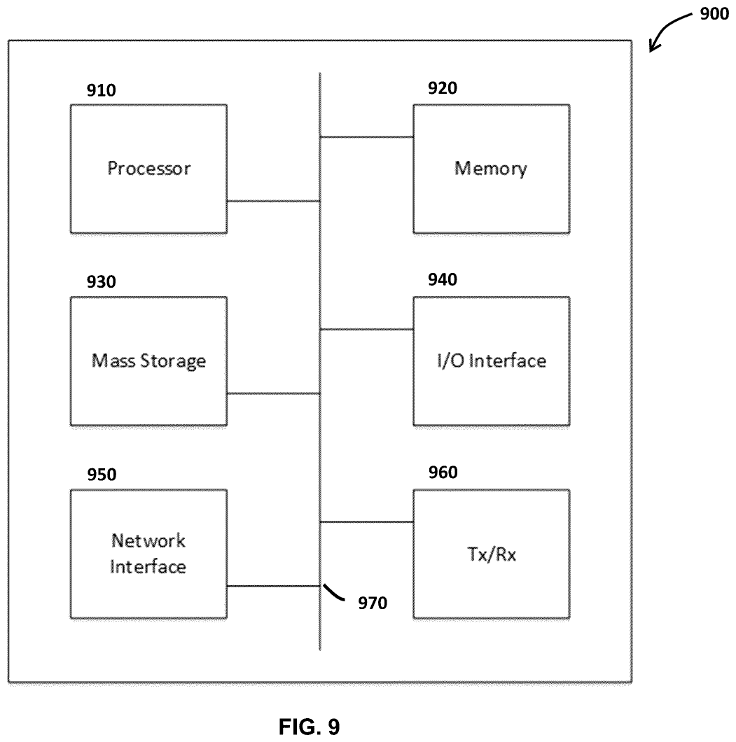

FIG. 9 is a schematic diagram of an electronic device 900 that may perform any or all of the steps of the above methods and features as described herein, according to different embodiments of the present disclosure. For example, end-user computers, smartphones, IoT devices, laptops, tablet personal computers, electronic book readers, gaming machine, media players, physical machines or servers, or other computing devices can be configured as the device in the disclosed methods. An apparatus configured to perform embodiments of the present disclosure can include one or more electronic devices for example as described in FIG. 9, or portions thereof.

As shown, the device includes a processor 910, such as a central processing unit (CPU) or specialized processors such as a graphics processing unit (GPU) or other such processor unit, memory 920, non-transitory mass storage 930, I/O interface 940, network interface 950, and a transceiver 960, all of which are communicatively coupled via bi-directional bus 970. According to certain embodiments, any or all of the depicted elements may be utilized, or only a subset of the elements. Further, the device 900 may contain multiple instances of certain elements, such as multiple processors, memories, or transceivers. Also, elements of the hardware device may be directly coupled to other elements without the bi-directional bus.

The memory 920 may include any type of non-transitory memory such as static random-access memory (SRAM), dynamic random-access memory (DRAM), synchronous DRAM (SDRAM), read-only memory (ROM), any combination of such, or the like. The mass storage element 930 may include any type of non-transitory storage device, such as a solid-state drive, hard disk drive, a magnetic disk drive, an optical disk drive, USB drive, or any computer program product configured to store data and machine executable program code. According to certain embodiments, the memory 920 or mass storage 930 may have recorded thereon statements and instructions executable by the processor 910 for performing any of the aforementioned method steps described above.

An electronic device configured in accordance with the present disclosure may comprise hardware, software, firmware, or a combination thereof. Examples of hardware are computer processors, signal processors, ASICs, FPGAs, silicon photonic chips, etc. The hardware can be electronic hardware, photonic hardware, or a combination thereof. The electronic device can be considered a computer in the sense that it performs operations that correspond to computations, e.g., receiving and processing signals indicative of image data, implementing a machine learning model such as a neural network model, updating parameters (weights) of the machine learning model, providing outputs of the machine learning model, etc. A machine learning model manager (e.g., a neural network manager) may be responsible for operating the machine learning model, for example by adjusting parameters thereof. The electronic device can thus be provided using a variety of technologies as would be readily understood by a worker skilled in the art.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any modifications, variations, combinations, or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device. The computer-readable medium may be non-transitory in the sense that the information is not contained in transitory, propagating signals.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

It is obvious that the foregoing embodiments of the disclosure are examples and can be varied in many ways. Such present or future variations are not to be regarded as a departure from the spirit and scope of the disclosure, and all such modifications as would be obvious to one skilled in the art are intended to be included within the scope of the following claims.

1. A method comprising:
distributing, by a network controller, a client-side model to a first plurality of client devices in a first cluster;
receiving, by a server, at least one transmission from each of the first plurality of client devices, each transmission including smashed data and information indicative of data used by a respective client device to generate the smashed data;
generating, by the server, gradients associated with the smashed data based at least in part on the transmissions from the first plurality of client devices;
transmitting, by the server, the gradients associated with the smashed data to the first plurality of client devices;
receiving, by the network controller, an updated client-side model from each of the first plurality of client devices;
generating, by the network controller, an aggregated client-side model based, at least in part, on the received updated client-side models from the first plurality of client devices; and
distributing, by the network controller, the aggregated client-side model to a second plurality of client devices in a second cluster.

2. The method of claim 1, wherein the server and the network controller are a single device.

3. The method of claim 1, wherein the information about data used to generate the smashed data includes one or more labels of data sampled by a client device of the first plurality of client devices.

4. The method of claim 1, wherein distributing the client-side model includes transmitting the client-side model to the first plurality of client devices in the first cluster.

5. The method of claim 1, wherein generating the gradients associated with the smashed data includes:
training, by the server, a server-side model using the smashed data from each of the first plurality of client devices; and
calculating, by the server, the gradients associated with the smashed data associated with a cut layer based at least in part on the trained server-side model.

6. The method of claim 1, wherein generating the aggregated client-side model includes generating the aggregated client-side model using a weighted average of the received updated client-side models, a weight in the weighted average based, at least in part, on a number of data samples used to generate the received updated client-side models.

7. The method of claim 1, further comprising:
prior to distributing the client-side model to the first plurality of client devices in the first cluster, determining, by the network controller, a client device clustering scheme, the client device scheme including at least assigning the first plurality of client devices to the first cluster and assigning the second plurality of client devices to the second cluster.

8. The method of claim 7, wherein determining the client device clustering scheme includes determining the client device clustering scheme based at least in part on communication link conditions and computing capabilities associated with one or more client devices from the first plurality of client devices.

9. The method of claim 1, wherein the first cluster and the second cluster have different sizes.

10. The method of claim 1, wherein transmitting the gradients associated with the smashed data includes transmitting the gradients associated with the smashed data via a wireless communication network.

11. The method of claim 10, further comprising:
prior to distributing the client-side model to the first plurality of client devices in the first cluster, determining, by the network controller, a resource management allocation between client devices of the first plurality of client devices.

12. The method of claim 11, wherein determining a resource management allocation includes:
collecting, by the network controller, at least one of channel conditions and computing capabilities of client devices in the first plurality of client devices;
allocating, by the network controller, at least one subcarrier to each client device in the first plurality of client devices to form an allocation of subcarriers;
calculating, by the network controller, a latency associated with the allocation of subcarriers to the first plurality of client devices; and
assigning, by the network controller, an additional subcarrier to a client device of the first plurality of client devices based at least in part on the latency associated with the allocation of subcarriers.

13. The method of claim 12, wherein the method further comprises determining whether there are further available subcarriers to assign and, if there are further available subcarriers to assign, repeating the steps of calculating the latency and assigning the additional subcarrier until all available subcarriers are assigned.

14. An apparatus comprising:
at least one processor; and
at least one machine-readable medium storing executable instructions which when executed by the at least one processor configure the apparatus to:
distribute a client-side model to a first plurality of client devices in a first cluster;
receive at least one transmission from each of the first plurality of client devices, each transmission including smashed data and information about data used to generate the smashed data;
generate a gradient associated with the smashed data based at least in part on the transmissions from the first plurality of client devices;
transmit the gradient associated with the smashed data to the first plurality of client devices;
receive an updated client-side model from each of the first plurality of client devices;
generate an aggregated client-side model based at least in part on the received updated client-side models from the first plurality of client devices; and
distribute the aggregated client-side model to a second plurality of client devices in a second cluster.

15. The apparatus of claim 14, wherein the apparatus is configured as one or more of an edge server, an access point and a network controller.

16. The apparatus of claim 14, wherein the information about data used to generate the smashed data includes one or more labels of data sampled by a client device of the first plurality of client devices.

17. The apparatus of claim 14, wherein distributing the client-side model includes transmitting the client-side model to the first plurality of client devices in the first cluster.

18. The apparatus of claim 14, wherein generating the gradient associated with the smashed data includes:
training a server-side model using the smashed data from the first plurality of client devices; and
calculating a gradient associated with the smashed data associated with a cut layer based at least in part on the trained server-side model.

19. The apparatus of claim 14, wherein generating the aggregated client-side model includes generating the aggregated client-side model using a weighted average of the received updated client-side models, a weight in the weighted average based, at least in part, on a number of data samples used to generate the received updated client-side models.

20. The apparatus of claim 14, wherein the executable instructions further configure the apparatus to:
determine a client device clustering scheme prior to distributing the client-side model to the first plurality of client devices in the first cluster, the client device clustering scheme including at least assigning the first plurality of client devices to the first cluster and assigning the second plurality of client devices to the second cluster.

21. The apparatus of claim 20, wherein determining the client device clustering scheme includes determining the client device clustering scheme based at least in part on communication link conditions and computing capabilities associated with one or more client devices from the first plurality of client devices.

22. The apparatus of claim 14, wherein the first cluster and the second cluster have different sizes.

23. The apparatus of claim 14, wherein transmitting the gradient associated with the smashed data includes transmitting the gradient associated with the smashed data via a wireless communication network.

24. The apparatus of claim 23, wherein the executable instructions further configure the apparatus to:
prior to distributing the client-side model to the first plurality of client devices in the first cluster, determine a resource management allocation between client devices of the first plurality of client devices.

25. The apparatus of claim 24, wherein determining a resource management allocation includes:
collecting at least one of channel conditions and computing capabilities of client devices in the first plurality of client devices;
allocating at least one subcarrier to each client device in the first plurality of client devices, to form an allocation of subcarriers;
calculating a latency associated with the allocation of subcarriers to the first plurality of client devices; and
assigning an additional subcarrier to a client device of the first plurality of client devices based at least in part on the latency associated with the allocation of subcarriers.

26. The apparatus of claim 25, wherein the executable instructions further configure the apparatus to determine whether there are further available subcarriers to assign and, if there are further available subcarriers to assign, repeat the steps of calculating the latency and assigning the additional subcarrier until all available subcarriers have been assigned.

27. A computer readable medium comprising instructions, which when executed by a processer of a device, cause the device to carry out the method of claim 1.

28. A computer program comprising instructions which, when the program is executed by a processor of a computer, cause the computer to carry out the method of claim 1.
